(19) United States
(12) Patent Application Publication
(10) Pub. No.: US 2026/0322633 A1
(43) Pub. Date: Oct. 15, 2026

(54) Tamper-Evident Timestamping of Emergency Transmissions Using Cryptographic Hashing and Distributed Ledgers

(71) Applicant: Dictation Sales & Services Inc DBA Equature, Southfield, MI (US)

(72) Inventors: Joe Mosed, Southfield, MI (US); Matt Carter, Lakeland, FL (US)

(73) Assignee: Dictation Sales & Services Inc DBA Equature, Southfield, MI (US)

(21) Appl. No.: 19/645,175

(22) Filed: Apr. 11, 2026

Related U.S. Application Data
(60) Provisional application No. 63/788,280, filed on Apr. 14, 2025.

(51) Int. Cl. H04L 9/00; H04L 9/06; H04L 65/1096; H04M 3/51

(52) U.S. Cl. CPC H04L 9/50; H04L 9/0643; H04L 65/1096; H04M 3/5116

(57) ABSTRACT

A system generates a cryptographic hash of emergency transmission data at ingestion, stores the hash in a distributed ledger, and enables verification of data integrity. The system provides tamper-evident storage and improved reliability.

### CROSS-REFERENCE TO RELATED APPLICATIONS

This application claims the benefit of U.S. Provisional Application Serial No. 63/788,280 Automated Quality Assessment of Emergency Transmissions, filed Apr. 14, 2025, the disclosure of which is incorporated in its entirety by reference.

### FIELD OF THE INVENTION

The disclosure relates to data integrity systems, and more particularly to cryptographic verification of emergency transmissions using distributed ledger technologies.

### BACKGROUND OF THE INVENTION

Emergency response systems, such as 911, receive millions of calls every year, requiring rapid and accurate classification to ensure timely and effective responses. Calls may be categorized by priority. For example, a higher priority is given to calls that indicate an immediate threat to life while a lower priority is given to calls such as traffic complaints, found bicycles, abandoned vehicles and the like. Currently, calls may be manually categorized. For example, as police or medical calls, and each of these may be further manually categorized into low-risk or higher-risk calls. Calls may also be manually categorized by disposition, meaning the ultimate outcome of the call. In many instances, because categorization is done manually, misclassification of calls may occur.

To improve emergency response systems, it is desirable to reduce, or eliminate, misclassification. Analysis if the “how” and “why” misclassification of calls may occur is a time-consuming and labor-intensive task that is often prone to human error in reasoning. The need for assessing the quality of automated classification systems that can accurately and efficiently categorize emergency calls has become increasingly important. Particularly, when machine learning and artificial intelligence are being used to automatically apply classifications to emergency transmissions.

Conventional emergency call handling systems suffer from inability to process streaming audio data within strict real-time latency constraints while maintaining classification accuracy. Existing systems either rely on post-call batch processing or utilize generalized transcription models that degrade under high-noise, high-stress emergency conditions. These limitations result in increased computational latency, inefficient use of processing resources, and reduced reliability of classification outputs within time-sensitive dispatch environments. Conventional systems are further limited by their inability to process streaming audio data under strict real-time constraints while maintaining classification accuracy.

Existing systems either (i) perform delayed, post-processing analysis or (ii) rely on generalized transcription models that degrade significantly under emergency call conditions. These limitations result in increased computational latency, inefficient resource utilization, and reduced reliability of classification outputs. The present disclosure provides a technological solution rooted in computer architecture and signal processing, including: (i) a streaming transcription engine optimized for high-noise, multi-speaker emergency audio, (ii) a classification engine configured to operate under dynamically adjustable accuracy thresholds tied to system latency constraints, and (iii) a synchronized processing pipeline that integrates transcription, classification, and dispatch communication in real time. These improvements collectively enhance the performance of computing systems operating in emergency response environments.

Computer-aided dispatch (CAD) systems allow a dispatcher to manage emergency calls and dispatch responders. Upon receiving a telecommunication from a 911 caller, the dispatcher advises the caller, sends emergency units, maintains records of the call, among other duties. The dispatcher uses codes that categorize the call.

Part of 911 dispatch is the need for quality control, which involves assessment of the dispatcher using predetermined criteria. Currently methods for identifying the dispatcher who assisted the caller are manual, which means they may be time consuming and prone to human error.

Yet another element of quality control is a need to prove the authenticity and integrity of the emergency call. Emergency transmissions, such as 911 calls, are vital for public safety and often serve as critical evidence in legal proceedings. However, the admissibility of such calls can be challenged due to disputes over timing, authenticity, or potential tampering. Existing systems rely on centralized logs, which are vulnerable to alteration and lack universal verifiability. While blockchain technology offers immutability, generic timestamping solutions are not specifically tailored to the unique requirements of 911 emergency calls, including real-time processing, emergency context, and seamless integration with Public Safety Answering Points (PSAPs).

### SUMMARY OF THE INVENTION

In contrast to conventional systems that perform post-call analysis or rely on generic speech-to-text processing, the disclosed system implements a latency-constrained, real-time processing architecture that synchronizes audio ingestion, transcription, classification, and dispatch output within operational timing requirements of public-safety answering points (PSAPs). The system improves computer system performance by reducing processing latency, increasing classification accuracy under high-noise and high-stress audio conditions, and enabling deterministic, machine-enforced dispatch decision support that cannot be achieved using manual or batch-processing systems.

In various embodiments, the issues described above may be addressed by a system and method for automated classification of emergency transmissions. The system and method comprising a call recording module to record audio of the call in real time, a transcription module to transcribe an audio recording of the emergency transmission into a text-based transcript, a comparison module reads the transcript and compares it to a predetermined data base of predefined classifications and prompts to identify possible classifications for tagging, a tagging module, using a machine learning algorithm, tags the transmission with relevant classifications that meet a predetermined accuracy rate, a quality assessment module to analyze call data and continuously improve the effectiveness and quality of calls, and a timestamping module for creating unalterable, court-admissible records of the call.

In various embodiments, the transcription module may be AI-powered. In various embodiments, the call recording module and comparison module use natural language processing (NPL). In various embodiments, the tagging module may incorporate a machine learning algorithm with a predetermined accuracy rate. In various embodiments, the system and method may include customization of classification categories, prompts, and accuracy rate to accommodate specific needs/wants of each emergency response center.

In various embodiments, a system and method for automatically identifying the dispatcher who took a call using voice matching technology is described. The system uses a cloud-based AI platform to compare the recorded call with pre-created voice profiles of dispatchers. The system assigns the dispatcher's name to the call, enabling efficient quality assessment and reporting.

In various embodiments, a system and method for timestamping 911 emergency calls using blockchain, specifically designed for integration within PSAPs. It involves real-time transcription of calls, generation of a cryptographic hash of critical metadata (e.g., call time, origin, duration), embedding the hash into a blockchain record, or transaction, and verification of the timestamp via a decentralized blockchain network. This process ensures legal integrity by providing irrefutable proof of when a call occurred and that it has not been subject to tampering.

It should be understood that the summary above is provided to introduce a simplified form of the inventive subject matter that are further described in the following detailed description. The summary is not intended to identify key or essential features of the claimed subject matter, the scope of which is defined by the claims that follow the detailed description. It should also be noted that the claimed subject matter is not limited to implementations that solve any disadvantages noted above or in any part of this disclosure.

### BRIEF DESCRIPTION OF DRAWINGS

The disclosure may be better understood from reading the following description of the non-limiting embodiments, with reference to the attached drawings.

FIG. 1 is a block diagram of a 911 system 100 having an automated classification system of the inventive subject matter;

FIG. 2 is a block diagram of the transcription module;

FIG. 3 is a block diagram of the comparison module;

FIG. 4 is a block diagram of the tagging module;

FIG. 5 is a block diagram of a customizable automated classification system;

FIG. 6 is a screen shot the comparison module;

FIG. 7 is a screen shot of the tagging module for multiple calls;

FIG. 8 is a screen shot of an output of the tagging module for a single call;

FIG. 9 is a block diagram of the assessment module;

FIG. 10 is a screenshot of tag creation;

FIG. 11 is a screenshot of the assessment module;

FIG. 12 is a block diagram of a method for automatically assigning a dispatcher to a call; and

FIG. 13 is a block diagram of a method for timestamping emergency transmissions.

### DETAILED DESCRIPTION OF THE INVENTION

The following detailed description relates to managing automated classification of emergency transmissions. Emergency transmissions may include, but are not limited to, emergency calls, radio transmissions, video interactions (body camera footage), text messages, and radio recordings to name a few examples. The classification of emergency transmissions, according to the inventive subject matter, increases the accuracy and efficiency of categorizing emergency calls to ensure timely and effective responses to emergency transmissions, such as 911 calls coming in to emergency response centers also known as public-safety answering points (PSAPs) located throughout the country. Hereinafter, we will refer to any of the examples of emergency transmissions listed above as “emergency calls.” The classification of emergency calls is related to whether the call is for a predefined category, such as Medical, Fire, Weapon, and Officer Safety. Thus, increasing the accuracy of the classification and the efficiency with which the classification is applied may increase the accuracy with which the proper emergency responders are dispatched while also decrease the time taken to dispatch the emergency responders. An accurate classification will result in the proper emergency responders being dispatched in response to the emergency. The efficiency with which the accurate classification is determined presents the advantage of decreasing not only the time it takes to identify the proper emergency responders but also the time it takes to dispatch them to the scene. Another advantage is that when the proper emergency responders are dispatched sooner, the safety of the public and the emergency responders themselves increases. Yet another advantage is that the prioritization and allocation of emergency responders is also improved.

The disclosure is based on the principle that the classification of the emergency call into the correct category may be determined using the dialogue between a caller, hereinafter referred to as “the caller,” and a representative of an emergency response center, hereinafter referred to as “the representative.” For example, the caller places a 911 call that is routed to a PSAP where a call recording module begins the call. A transcription module employs Artificial Intelligence (AI), such as a speech-to-text algorithm, which may be trained to transcribe the audio recording, in real time, into a text-based transcript. A comparison module reads the text-based transcript may be read, also in real time, by way of a natural language processing (NLP) module that compares text in the transcript to a database of predefined classifications and prompts. Prompts may also be customized, to be as simple or as complex, as needed on a case-by-case basis.

A tagging module tags the calls with relevant classifications identified by the NLP module. The tagging module may employ a machine learning algorithm, in which case, an accuracy rate limit, or threshold, is predetermined. The accuracy rate of a machine learning algorithm is the percentage of correct predictions a model makes, and it is a common metric used to evaluate a model's performance. The accuracy rate is calculated by dividing the number of correct predictions by the total number of predictions made. The result is expressed as a percentage between 0% and 100%. So the predetermined accuracy rate limit is adjustable and may be set, for example, by the emergency response center. In one or more embodiments, the accuracy rate limit may be set between 70%-90%.

The inventors have recognized that managing the classifications identified by the NLP may differ between emergency response centers. For example, an emergency response center in an urban setting has many more resources for emergency responders. Whereas an emergency response center in a more rural setting is likely to have fewer resources at their disposal. Therefore, a rural emergency response center may customize the classification of categories prompts and accuracy differently than an urban emergency response center because of their differing operational priorities. In any event, the NLP module is continuously trained by feeding previously labeled transcripts and corresponding ground truth classifications to improve classification accuracy over time.

A quality assessment process module 900 utilizes metadata to evaluate the effectiveness of the call both live and post-call for quality control and performance feedback based on predetermined assessment criteria. Voice matching technology, integrated with the call recording module, allows for automatic identification and assignment of dispatchers without manual intervention.

A blockchain integration module 1100 timestamps calls to ensure integrity and admissibility in legal proceedings.

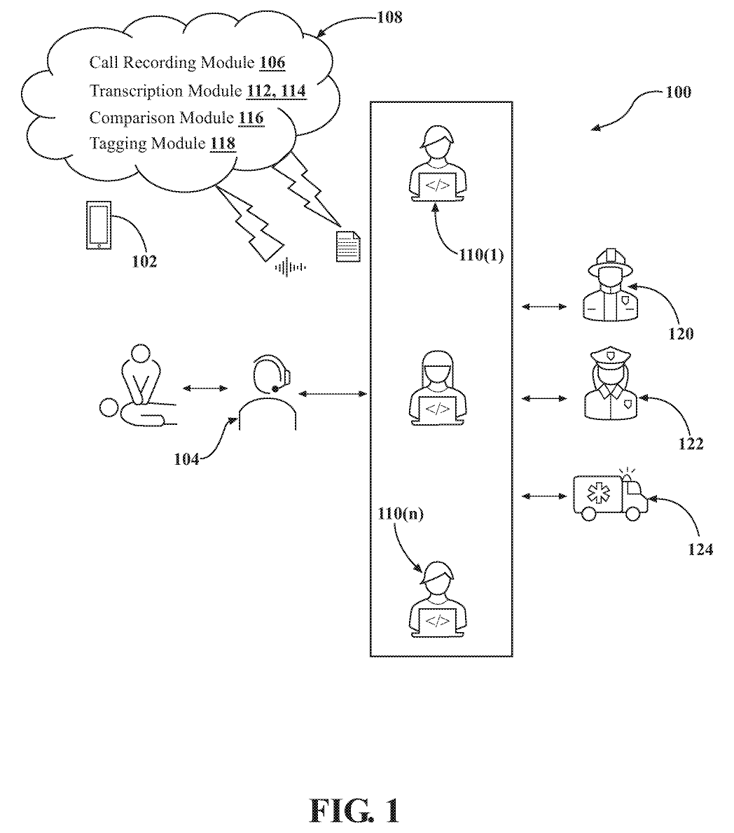

Referring to FIG. 1, a simplified block diagram of a 911 system 100 having automated classification system 108 using artificial intelligence (AI) and blockchain timestamping is shown. A caller 102 places a call to the emergency response center. A call recording module 106 begins capturing audio, in real time, at the PSAP when a representative 104 answers the call. The call recording module 106 sends the recorded audio, in real time, to the automated classification system 108. The automated classification system 108 may be implemented in one or more embodiments, including, but not limited to, a software-as-a-service (SaaS) model, an on-premise model, or a hybrid model. The SaaS model has a system hosted on a cloud-based platform and is accessible through a web-based interface. The on-premise model has a system installed and maintained at a server local to the emergency response center. The hybrid model has a cloud-based platform that is integrated with on-premise systems at the emergency response center. It should be noted that FIG. 1 shows the SaaS model for example purposes only.

The call recording module 106 records audio of the emergency response center that receives the call. 911 call recording systems are designed to meet the standards of the National Emergency Number Association (NEMA) and the Association of Public Safety (APCO). However, each emergency response center has different capabilities based on the location of the PSAP and different operational priorities. For example, if the PSAP is in a large urban area vs. a small rural area. The representative 104 is trained to keep the caller 102 talking to gather as much information as possible to feed to dispatchers 110(1) – 110(n) and emergency responders 120, 122, 124. Many times the caller 102 may be very distraught making it difficult for the representative 104 to determine what the emergency is and what emergency response teams services may be needed. The automated classification system 108 of the present invention helps to eliminate guesswork on the part of the representative 104 enabling the representative 104 to get useful information to the dispatchers, and ultimately the emergency response teams, much quicker and more reliably than manual classification methods.

As audio 106 is received it is being recorded, in real time, by a call recording module 106, and stored as a digital file. The audio is also processed as a continuous real-time stream, segmented into sequential audio frames and ingested into a streaming processing pipeline. The pipeline is configured to minimize buffering delays and enable concurrent execution of transcription, metadata extraction, and classification operations.

The recorded audio is transcribed by the automated classification system 108 using a transcription module 112 where it is transcribed into text 114. At this stage, key metadata is also extracted. For example, a start time, a duration of the call, a caller ID (if available), and an identifier associated with the PSAP. Simultaneously, a cryptographic hash of the extracted metadata and the audio file is generated. The transcription module 112 operates on structured feature representations derived from the transcript, rather than unstructured text alone, thereby reducing computational complexity and improving the determination of classifications.

A comparison module 116 then reads the transcribed text 114 and performs a comparison to a database of predefined classifications and prompts to identify matches in the transcribed text 114. The matches are processed at a tagging module 118 wherein they are tagged with a proper classification that can be communicated to the representative 104 and the dispatchers 110(1)-110(n). An assessment module 900 allows a user to assess critical patterns, provides support for advanced reporting, and allows a deeper understanding of operations associated with public safety response.

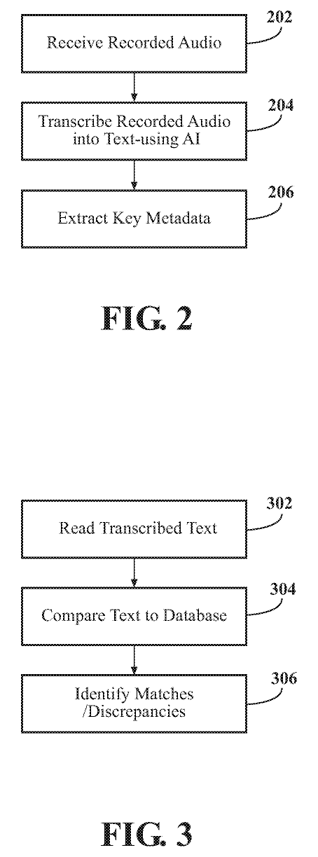

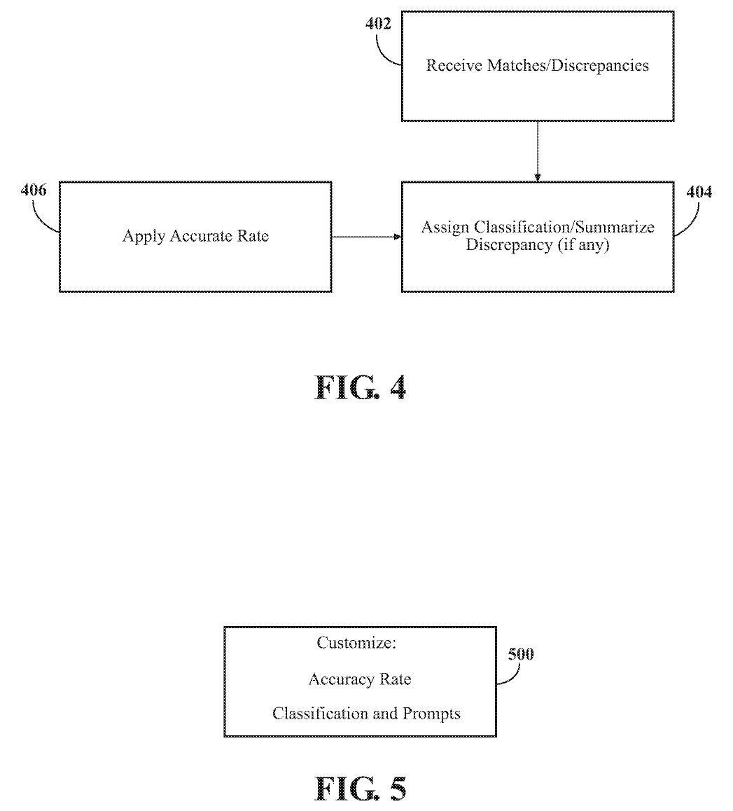

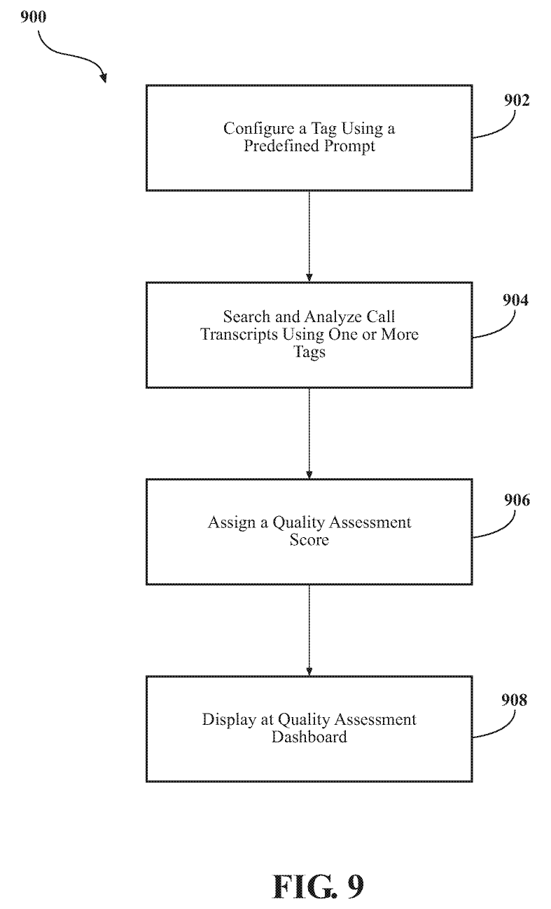

The transcription module 112 will be described in further detail with reference to FIG. 2. The comparison module 116 will be described in further detail with reference to FIG. 3. The tagging module 118 will be described in further detail with reference to FIG. 4. The assessment module 900 will be described in further detail with reference to FIG. 9.

Once the tagging module 118 (also called the classification module) assigns the proper classification(s) using matches in the transcript 114, the classification(s) are sent back to the representative 104 and the necessary dispatcher(s) 110(1)-110(n) may be immediately notified by the representative 104 so that any one or more of the emergency response teams, i.e., fire 120, police 122, or paramedic 124, that may be needed based on the classification(s) identified and assigned by the automated classification system may be dispatched. In one or more embodiments, the transcription module implements a low-latency streaming inference architecture that processes segmented audio frames in near real time, thereby reducing buffering delays associated with batch transcription systems. The transcription model is further trained on domain-specific emergency audio datasets, enabling improved recognition accuracy under conditions of background noise, emotional speech variation, and overlapping speakers. This results in improved computational efficiency and reduced error propagation to downstream classification modules.

FIG. 2 is a more detailed block diagram 200 of the transcription module 112. The recorded audio 106 is received 202 at the transcription module 112 where it is transcribed 204 into text 114 and key metadata is extracted 206. Typically an application interface (API) uses speech recognition to convert audio into text. Live transcription is possible, as well as multiple-speaker recognition and multiple-language capabilities. The transcription process may use artificial intelligence to further enhance the identification of spoken words and the conversion of them into text. As discussed above, the caller 102 during a 911 call is stressed, making it difficult for the representative 104 to interpret the substance of the call. However, even a “normal” speech recognition API may not be sufficient for the specificity associated with 911 calls and the emotional state of the caller 102. The transcription module 112 of the present invention is highly specific to an emergency call setting, making its accuracy much more predictable given the nature of the circumstances surrounding 911 calls.

The transcription module 112 uses algorithms, data, and computational power to simulate human intelligence that is specific to emergency situations. Through identification of patterns and relationships using stored data, new data, and even previous errors, the transcription algorithms can continuously adapt and learn to become more accurate at transcribing what can, at times, be almost incoherent to the representative 104.

Key metadata is extracted 206 from the transcribed recorded audio to be used by other modules for comparison, tagging, quality assessment, and authentication of the call. Examples of key metadata that is extracted include, but are not limited to, start time, call duration, caller ID, PSAP identifier.

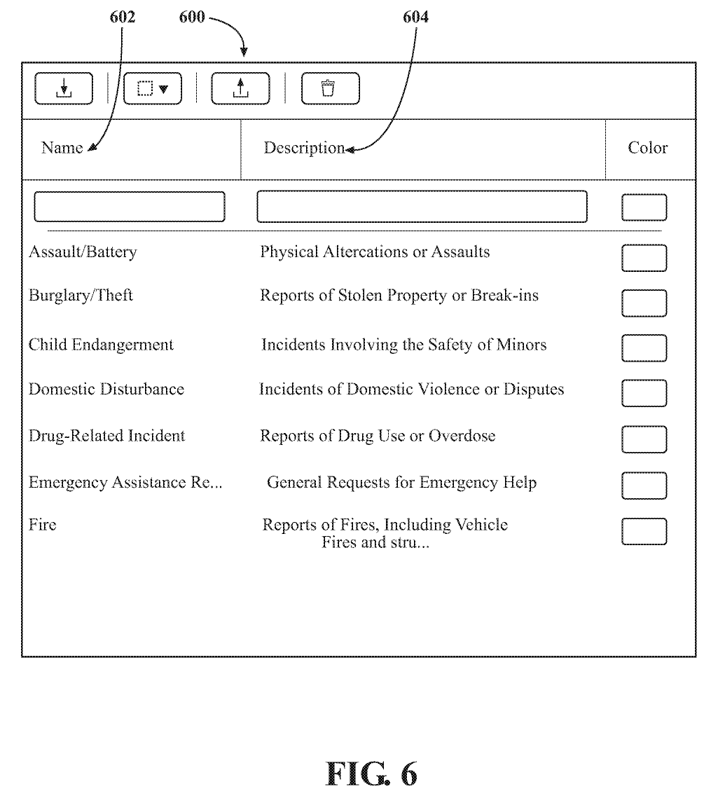

FIG. 3 is a more detailed block diagram 300 of the comparison module 116 of the automated classification system 108. The comparison module 116 reads 302 the transcribed text 114 and compares 304 text in the transcript to a predetermined data base of classifications and prompts so that classifications may be assigned automatically based on the content and context of the transcribed audio. FIG. 6 is a screen shot 600 showing an example list of classifications 602 and prompts 604 that may be applied to the transcribed text for the purpose of automatically assigning a classification to the call. Customized classifications 602 and prompts 604 may be customized to add detail as desired for analyzing the text of the call. This will be described in detail later herein.

Matches and discrepancies, if any, are identified 306 using an NLP models specific to 911 calls. Machine learning (ML) NLP models are trained by being fed examples of words and phrases (prompts) within the context of an emergency call, allowing the model to learn to interpret the transcribed text 114. The data base is continuously updated to statistically improve the accuracy of the NLP models. Matches are automatically assigned appropriate classifications.

In one or more embodiments, the classification process is executed using a resource-aware inference engine that dynamically adjusts classification thresholds based on system load, latency requirements, and available computational resources. Unlike conventional static classifiers, this approach enables adaptive trade-offs between accuracy and processing speed, thereby improving real-time system performance.

Additionally, the classification module operates on structured feature representations derived from streaming transcription data, rather than raw text alone, thereby reducing computational complexity and improving classification determinism. This structured processing architecture improves the functioning of the computing system itself by enabling faster and more reliable classification outputs.

FIG. 4 is a more detailed block diagram 400 of the tagging module 118 of the automated classification system 108. The tagging module operate on structured feature representations derived from the transcript, rather than unstructured text alone, thereby reducing computational complexity and improving classifications. The tagging module 118 receives 402 the matches identified by the comparison module 116 and assigns 404 corresponding classifications and prompts to the call. There may be multiple classifications assigned to a single 911 call, resulting in dispatch of more than one type of emergency response service. In real time, the classifications are sent 408 to the representative 104 and the representative communicates with one or more dispatchers 110(1)-110(n) as needed to accommodate the situation. Post call, the assigned classifications may be used for purposes of searching, reporting, and quality assessment.

In one or more embodiments, the tagging module 118 employs a resource-aware inference mechanism that dynamically adjusts classification thresholds based on system latency requirements, available processing resources, and real-time operational constraints. This enables adaptive balancing of classification accuracy and processing speed.

The tagging module 118 applies a predetermined accuracy rate limit, or threshold, (hereinafter accuracy rate) 406 (which may also be customizable) to the step of assigning 404 classifications. For example, the predetermined accuracy rate 406 may be adjustable by the emergency response center so as to reflect the resources available to the center. In another example, the predetermined accuracy rate 406 may be set according to not only the level of accuracy, but also the speed in which a response is needed.

FIG. 5 is a block diagram of a customizable automated classification system 500. In addition to the adjustability of the accuracy rate, the automated classification system 500 of the inventive subject matter is also capable of customizing classifications and prompts.

The accuracy rate is related to how often a correct prediction is made and while an accuracy rate of 100% is desirable, it is not always achievable. According to the inventive subject matter, the accuracy rate may be customized, by accuracy settings, based on how the classification system is being applied to the recorded audio. For example, if the recorded audio is being analyzed after the fact, the accuracy rate may be set high so that an accurate classification is achieved. However, in instances where the call is being recorded, transcribed and classifications are being applied in real time, the accuracy rate may be set lower when speed takes precedence over accuracy.

The prompts, which are also customizable, are a description of the subject matter that the classification system 500 is researching to apply classifications to the call. The prompt may be as simple or as complex as desired and may depend on the desired outcome of the “classification. For example, a simple prompt may be used for applying a classification of “Burglary/Theft” to a call. The prompt may be as simple as “reports of stolen property or break-ins.” In another, more complex example, for a classification of “Address Mismatch,” the prompt may be as complex (or more) as “please analyze the following transcript to detect any discrepancies in the address mentioned by the caller and the dispatcher. Only compare full addresses that are mentioned at least twice by both parties, and only provide output if a discrepancy is found.”

Following the steps in modules depicted in FIGS. 2-4, an example of the classification system with a customized prompt is provided. Customizing the prompt provides the flexibility to analyze items of interest in the recorded/transcribed text. Using the exemplary complex prompt described above for classification of “Address Mismatch,” the system receives 202 the recorded audio 106 and transcribes 204 the audio 106 (see FIG. 2). Referring back to FIG. 3, the transcribed text is read 302 by the classification system. In the present example, the system is reading 302 the transcribed text to identify repeated addresses. This is accomplished by extracting full addresses that are mentioned by the caller. Full addresses may include street numbers, street names, and any additional location details provided. Furthermore, any full addresses that are acknowledged, repeated, or recorded by the representative and/or dispatcher are extracted.

In real time and post call, the system compares 304 the extracted text and matches and discrepancies are identified 306. As indicated above, full addresses, street numbers, street names, apartment unit numbers, and other relevant location details from the caller and the representative and/or dispatcher are used in this comparison.

Referring now to FIG. 4, identified matches and discrepancies are received 402. When no discrepancies (i.e., only matches) are identified, there is no need to apply “Address Mismatch” classification to the call. However, the full addresses, emphasized through repetition are critical for emergency response and it should be a goal of the representative and/or dispatcher to extract that information from a caller.

If discrepancies are found, the classification “Address Mismatch” is applied, and further steps may be taken. The system may highlight and document discrepancies such as transposed numbers, misspellings or mispronunciations of street names, incorrect numbers, or names, missing or additional information, confusion between similar-sounding addresses. The system may provide specific details about the discrepancies.

Finally a summary of the call may be provided by summarizing the correct address, summarizing the address provided by the caller, summarizing the address understood by the representative and/or dispatcher. The system may go further to explain any potential impact the Address Mismatch had on the outcome of the call interaction and emergency response that was dispatched in response to the call interaction.

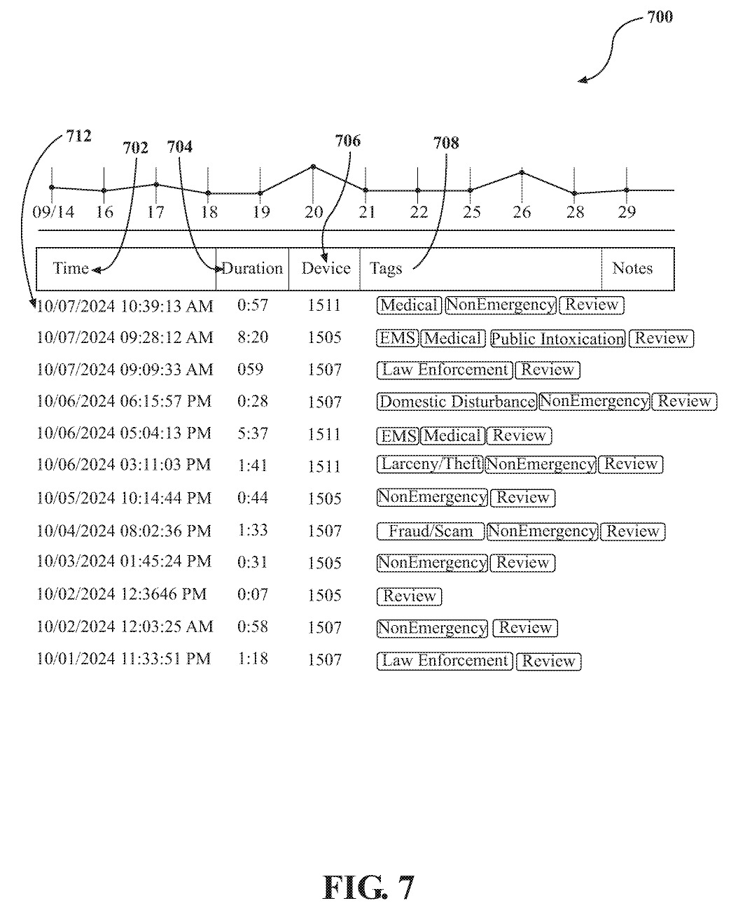

FIG. 7 is a screenshot 700 of an example output of the tagging module of the automated classification system. The log shows data for calls taken during the time period of Oct. 1, 2024, through Oct. 7, 2024. Column 702 date and time the call was received. Column 704 presents the duration of the call. The column 706 with the heading “Device” identifies the equipment that received the call. The column 710 with the heading “Tags” includes all the classifications that were automatically assigned during the duration of the call based on the recorded audio, the transcribed text, and any comparison to prompts for classifications. For example, the first line 712 shows a call received at 10:39:13 am that lasted for fifty-seven seconds taken by a representative at device 1511. The audio of the call was analyzed and the classifications “Medical,” “Non-Emergency,” and “Review” were all assigned to the call. These classifications, as they are assigned, allow the representative to dispatch the proper emergency responders while the call is taking place.

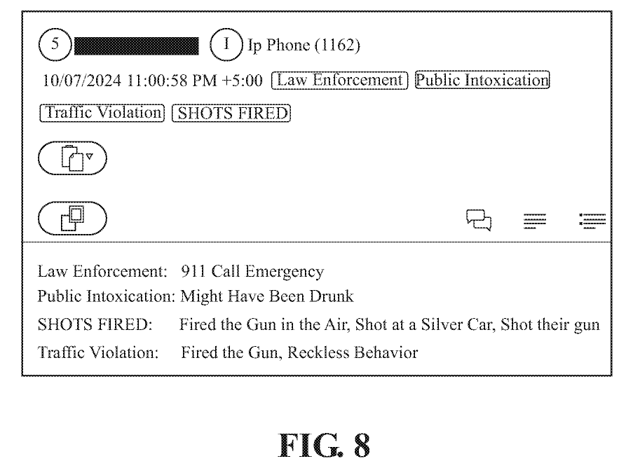

FIG. 8 is a screenshot 800 of the output of the tagging module for a single call, the number of which has been blacked out in FIG. 8. The classifications 802, shown as color-coded blocks in the screenshot, which were assigned to the call include “Law Enforcement”, “Public Intoxication”, “Shots Fired”, and “Traffic Violation”. The tagging module output for each call lists each classification 802 along with a reason 804 why that tag was applied. For example, in the example shown in FIG. 8, the classification “Law Enforcement” was assigned because a 911 call was received, and it was related to an emergency situation. The classification “Public Intoxication” was assigned because the caller described a subject that “might have been drunk.” The classification “Shots Fired” was assigned because the caller described events such as the subject “fired a gun in the air,” “shot at a silver car,” and “shot their gun.” Finally, the classification of “Traffic Violation” was assigned because the caller described the acts of reckless behavior and firing a gun during the call.

After the call is managed and the appropriate emergency responders are dispatched, there may be a need to review the classifications that were assigned to one or more calls by the tagging module. The classification assignments may be further analyzed using even more customized prompts to evaluate and assess, in hindsight, the accuracy of the classifications and to identify matches or discrepancies that are of interest to the call centers, first responders, city services, etc. Upon evaluation, a “score” that is representative of a system control, such as the quality of the call, is assigned. The emergency responders may use this information to improve their systems. This information is also stored in a database and used to train the tagging module.

Using the example of an “Address Mismatch” described above, it is estimated that ten thousand lives per year could be saved by reducing response times to the correct location. Further, for every minute saved in response time to an emergency call, mortality is known to be reduced by 7-10%. Therefore, the accuracy and appropriateness of classifications that are assigned by the tagging module are extremely important to the overall improvement to public safety response to emergency transmissions, and particularly 911 calls.

FIG. 9 is a block diagram of the quality assessment process module 900. Tags are configured 902 using predefined prompts 604. The tags are applied by the tagging module described above. The predefined prompts 902 address matters that are of interest to those assessing the accuracy of the classifications assigned by the tagging module. The predefined prompts 902 may be selected by a user, as by way of a drop down menu from a user interface. Alternatively, or additionally, the predefined prompts 604 may be customized by a user. Referring again to the screenshot shown in FIG. 6, customized predefined prompts 902 may be selected from a dropdown and/or entered in the blank “description” field. The customized prompts are designed to evaluate the accuracy and relevance of the classifications that were assigned by the tagging module.

The quality assessment module 900 uses predefined prompts, shown as 604 in FIG. 6, to search and analyze 904 the results of the tagging module, focusing on configurable thresholds that are set to assess transcription accuracy, call categorization, call prioritization, among other factors. The predefined prompts 604 used for quality assessment may be as simple as desired, or as complex as desired. For example, a prompt 604 may be as simple as identifying an incident, like a structure fire, making it easy to categorize and locate similar calls for assessment. Additionally, or alternatively, prompts 604 may be complex to capture detailed scenarios and more nuanced information. For example, specific phrases, types of incidents, caller behaviors, or even context-specific keywords, may be used to identify multiple elements. This may include a single call or multiple calls. This allows a user to assess critical patterns, provides support for advanced reporting, and allows a deeper understanding of operations associated with public safety response.

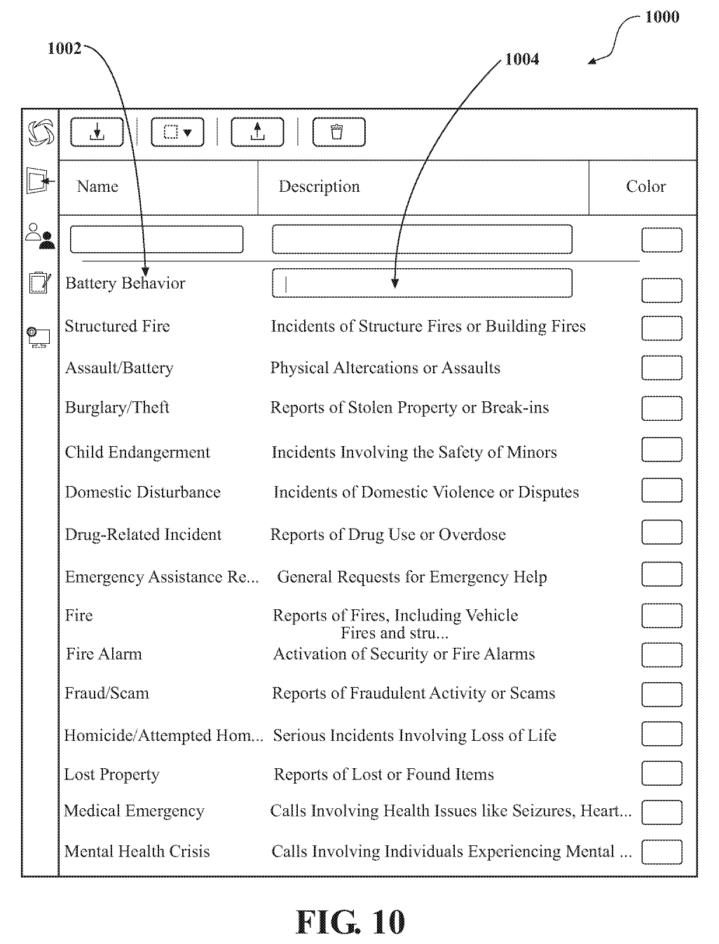

FIG. 10 is a screenshot 1000 of a configuring a tag using a customized predefined prompt. A tag 1002 identified as “Bad Behavior” is configured using a customized prompt 1004. The language for the customized prompt 1004 is detailed and is entered by a user at the “description” field shown in FIG. 10. In the present example, the prompt, entered in the “description” field 1004 is customizable and may read, for example, “Analyze the following 911 call transcript between the dispatcher and the caller. Identify and report any instances where the dispatcher exhibits bad behavior. Bad behavior includes, but is not limited to, the following: 1. Use of Profanity or inappropriate Language: Any swear words, slurs, or derogatory terms. Language that is unprofessional or offensive. 2. Rudeness or unprofessional Attitude: Dismissive or sarcastic remarks. Interrupting the caller unnecessarily. Speaking in a condescending tone. 3. Loack of Empathy or Concern: Indifference to the caller’s situation. Failure to acknowledge the caller’s emotions. Not providing reassurance.”

Once the tag 1002 is configured by way of the customized prompt 1004 entered into the description field, the tag will show up on any corresponding call, providing instant context, helping to quickly identify and prioritize the call based on the defined criteria, creating a dashboard for relevant information.

Referring back to FIG. 9, the results of any analysis using tags are a comprehensive quality assessment, over long term data sets, whereby a scoring system assigns 906 a quality assessment score. The quality assessment score 908 is representative of the overall quality of the call transcription and/or call interaction. The scoring system used to assign 906 the quality assessment score may be viewed at a comprehensive quality dashboard 910. Based on the evaluation of the call transcription and/or call interaction, the quality assessment score characterizing the quality of call handling or call classification is generated. The quality assessment score is further based on metrics derived from multiple calls over a predetermined period, producing aggregate performance statistics for dispatchers or PSAPs.

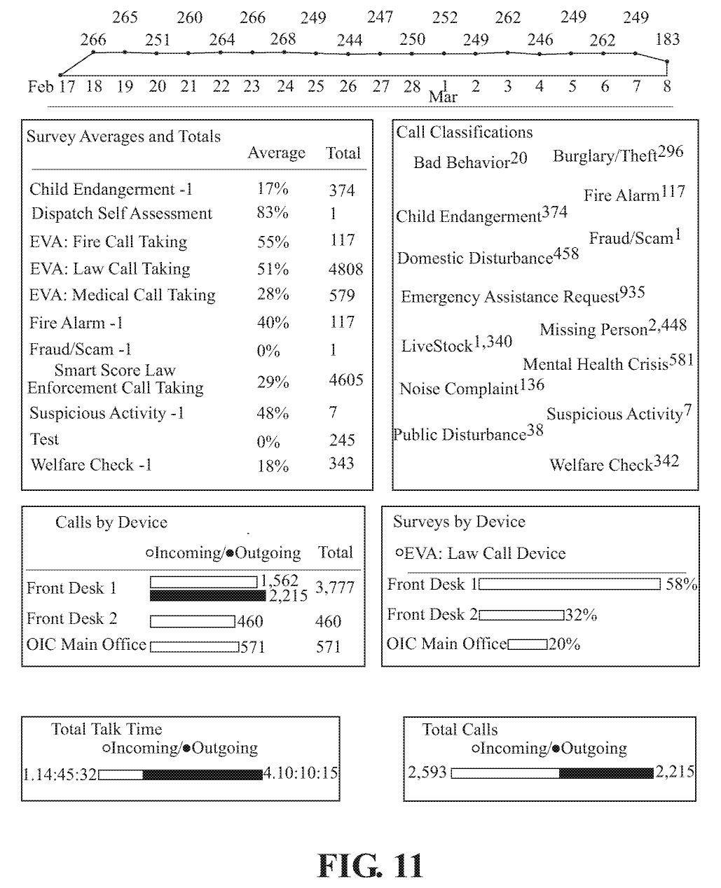

FIG. 11 is a screenshot of a dashboard 1100 showing an analysis of calls received by the automated classification system 108 over a predetermined period of time. The automated classification system 108 generates and assigns a smart score as a means to assess the quality of the system.

In one or more embodiments, it is useful for the automated classification system to automatically identify the dispatcher 104, 110(1)-110(n), who took a call. This may be accomplished using voice matching technology. The system 108 uses a cloud-based AI platform to compare the recorded call with pre-created voice profiles of dispatchers. The system 108 assigns the dispatcher's name to the call, enabling efficient quality assessment and reporting.

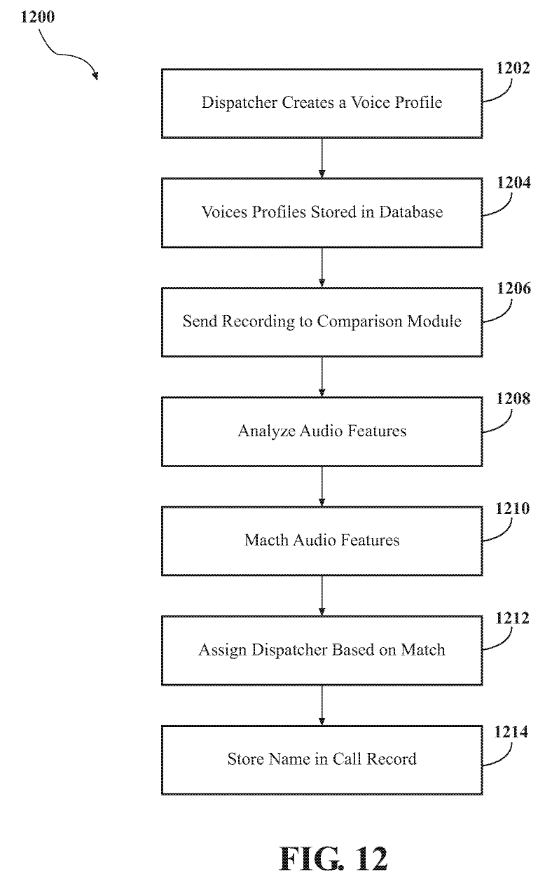

FIG. 12 is a method for automatically assigning a dispatcher to the call. At step 1202, each dispatcher creates a unique voice profile. The voice profiles are stored 1024 in a database. The voice profile may include the name of the dispatcher, the PSAP identifier to which the dispatcher is assigned, and a set of audio features, such as pitch, tone, and cadence that distinctly identify the dispatcher. For example, biometric voice identification technologies may be used to generate a biometric footprint of the dispatcher to identify the dispatcher when matching a voice profile that is stored in the database.

When the call recording module 106 records the recording is sent 1204 to the comparison module 116, using an AI cloud platform, compares 1206 the recorded audio of the call with the stored voice profiles. Machine learning algorithms are used to analyze 1208 the audio features and identify 1210 the best match.

Upon identifying 1210 the best match, the assessment module 900 assigns 1212 the dispatcher's name to the call record based on the voice match, wherein the assigned dispatcher's name is stored 1214 in the call record and can be used for quality assessment and reporting post call. The identification of the dispatcher may occur in real time, or post call.

Because the automatic assignment of the dispatcher is cloud-based, it is scalable and flexible so that it may be used across multiple PSAPs.

Voice profiles and call records may be stored in a secure database with encryption protocols, ensuring compliance with privacy regulations such as HIPAA.

This automated assignment enables easy identification of calls managed by each dispatcher for searching, reporting and analysis. The system provides insights into dispatcher performance, enabling targeted training and quality improvement.

A blockchain-based timestamping module improves data integrity verification in distributed computing environments by preventing modifications to call records without detection. This addresses a technical limitation of current centralized logging systems. In one or more embodiments, the timestamping module is integrated directly into the real-time processing pipeline such that metadata and audio-derived features are hashed at the point of ingestion, prior to storage or downstream processing. This prevents post-processing modification and ensures data integrity at the system level.

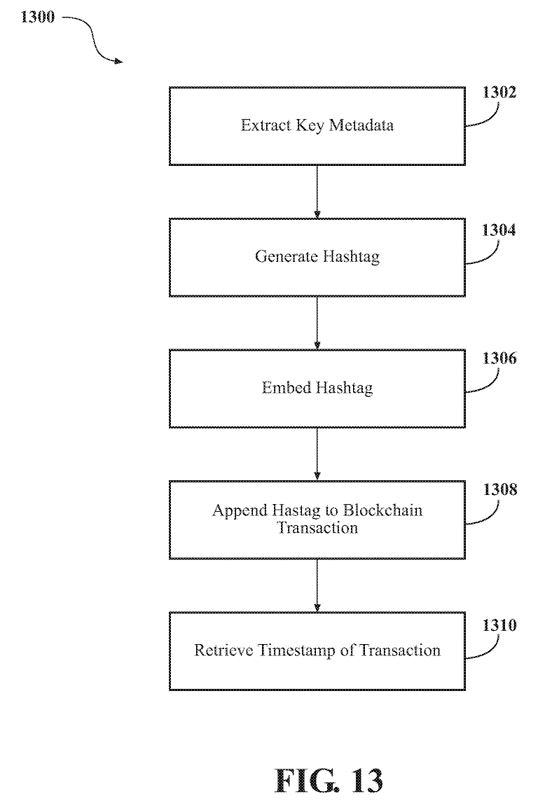

FIG. 13 is a flowchart of a method 1300 for timestamping 911 emergency calls using blockchain, specifically designed for integration within PSAPs. As described earlier herein, the method uses the real-time transcription of calls in the transcription module 112, 114 to extract 1302 key metadata and generate 1304 a cryptographic hash of critical metadata (e.g., call time, origin, duration). The cryptographic hash generator may be configured to include call tags generated by the automated classification system 108. For example, but not limited to medical, fire, police, etc. The cryptographic hash is generated synchronously with ingestion of the real-time audio stream, prior to downstream processing or storage, thereby preventing post-processing alteration. The hashtag process is integrated into the streaming pipeline to reduce computational overhead and eliminate redundant data processing operations.

The method embeds 1306 the cryptographic hash into a blockchain record, (or transaction). The generation and embedding of the cryptographic hash is performed using a deterministic hashing process synchronized with the transcription and classification pipeline, thereby reducing computational overhead and eliminating the need for redundant data processing operations. This integration improves the efficiency and security of distributed computing systems handling emergency transmission data.

The cryptographic hash is appended 1308 to a blockchain transaction that is broadcast 1310 to a blockchain network, such as Bitcoin, which is typically mined within ten minutes.

The PSAP retrieves 1310 the timestamp from the blockchain network to be exported as a legal affidavit of the timing and integrity of the call. For example, a 911 call reporting a shooting is received at 14:35:02 UTC. The system hashes the call's metadata (time, caller ID) and audio, embedding it into Bitcoin transaction abcd1234..., which is mined at 14:40:00 UTC. In a subsequent court proceeding, the PSAP verifies the hash against block 870,000, providing irrefutable proof of the call's timing and integrity, making it admissible under legal doctrines such as "excited utterance" (Raymond v. State, 2019).

Blockchain is inherently designed to prevent tampering so it offers a low-cost solution to timestamping that otherwise requires the use of an expensive, proprietary software system. Each block in a blockchain is linked to its predecessor through cryptographic hashes, creating a secure chain of information. If a hacker attempts to alter any block, the hash of that block would change, rendering all subsequent blocks invalid. This decentralized nature of a blockchain network ensures global verification that meets the scrutiny of legal standards such as the Confrontation Clause, Crawford v. Washington, 541 U.S. 36 (2004).

It is recognized that the method described herein uses controllers that may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform o include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein.

In addition, such controllers as disclosed utilize one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

The disclosed system provides several technical advantages over conventional systems, including but not limited to: reduced end-to-end processing latency through a synchronized streaming pipeline, improved transcription accuracy under high-noise and multi-speaker domain-specific model training, adaptive classification performance through dynamic thresholding tied to system constraints, improved data integrity via real-time cryptographic hashing integrated into the processing pipeline, and reduced computational overhead through structured data processing and elimination of redundant operations. These improvements represent specific enhancements to computer functionality and processing efficiency, rather than mere automation of human activity.

While the present invention has been described in relation to particular embodiments, many other variations and other uses will be apparent to one skilled in the art. The inventive subject matter is not limited to the specific disclosure herein, but only by the nature and scope of the disclosure.

What is claimed is:

1. A computer-implemented method for verifying integrity of an emergency call transmission, comprising:
receiving audio data associated with an emergency transmission;
extracting metadata from the audio data;
generating, at an ingestion stage, a cryptographic hash of at least a portion of the audio data and the metadata;
embedding the cryptographic hash into a transaction of a distributed ledger;
transmitting the transaction to a network associated with the distributed ledger; and
storing a reference to the transaction for subsequent verification of integrity.

2. The method of claim 1, wherein the cryptographic hash is generated in real time.

3. The method of claim 1, wherein the metadata includes call timing information.

4. The method of claim 1, wherein the distributed ledger comprises a blockchain network.

5. The method of claim 1, wherein the cryptographic hash included classification data.

6. The method of claim 1, wherein the transaction is verified by a decentralized network.

7. The method of claim 1, wherein the hash generation is synchronized with audio ingestion.

8. The method of claim 1, further comprising verifying integrity by comparing a recalculated hash to the stored hash.

9. The method of claim 1, wherein the stored reference is used in a legal proceeding.

10. The method of claim 1, wherein the distributed ledger prevents modification of stored records.

11. A system comprising processors and memory configured to perform the method of claim 1.

12. A non-transitory computer-readable medium storing instructions to perform the method of claim 1.

13. The method of claim 1, wherein the cryptographic hash is generated using a deterministic hashing algorithm.

14. The method of claim 1, wherein the transaction includes a timestamp corresponding to the emergency transmission.

15. The method of claim 1, wherein the audio data includes at least one of voice or text-derived data.
